(19) United States
(12) Patent Application Publication
(10) Pub. No.: US 2025/0370941 A1
(43) Pub. Date: Dec. 4, 2025

(54) DMA STRATEGIES FOR AIE CONTROL AND CONFIGURATION

(71) Applicant: XILINX, INC., San Jose, CA (US)

(72) Inventors: Juan J. NOGUERA SERRA, San Jose, CA (US); Patrick SCHLANGEN, Köln (DE); Javier CABEZAS RODRIGUEZ, Austin, TX (US); David Patrick CLARKE, Dublin (IE)

(21) Appl. No.: 18/679,366

(22) Filed: May 30, 2024

(51) Int. Cl. G06F 13/28; G06F 9/30; G06F 13/16

(52) U.S. Cl. CPC G06F 13/28; G06F 9/30043; G06F 13/1668

(57) ABSTRACT

Embodiments herein describe using DMA circuitry in multiple tiles in a hardware accelerator array to program the DMA operations within the array. For example, a system on a chip (SoC) may include a controller that is external to the hardware accelerator array. While the controller can be used to program the DMA circuitry within the array, this can be slow since the controller may be compute limited. Instead, the embodiments herein describe techniques where the controller is provided pointers to the register read and write corresponding to the DMA operations. The controller can provide these pointers to multiple DMA engines in the hardware accelerator array (e.g., DMA circuitry in interface tiles) which fetch the DMA operations and program themselves, as well as other DMA circuitry in the array.

### TECHNICAL FIELD

Examples of the present disclosure generally relate to using direct memory access (DMA) to control and configure a hardware accelerator.

### BACKGROUND

Typically, a hardware accelerator is an input/output (IO) device that is communicatively coupled to a CPU via a PCIe connection. The CPU and hardware accelerator can use direct memory access (DMA) and other communication techniques to share data. That is, DMA can be used to move data into the hardware accelerator for processing.

These DMA operations are typically configured or established using a binary, which is generated by a compiler. Deriving the DMA operations from the binary, and pushing these DMA operations to the DMA engines in the hardware accelerator can require significant resources.

### SUMMARY

One embodiment described herein is a method that includes loading pointers into direct memory access (DMA) circuitry in multiple tiles in a hardware accelerator array where the pointers indicate storage locations of DMA operations, fetching, by the DMA circuitry in the multiple tiles, the DMA operations using the pointers, and configuring in parallel, by the DMA circuitry in the multiple tiles, DMA circuitry in multiple columns of the hardware accelerator to perform the DMA operations.

One embodiment described herein is a hardware accelerator array that includes multiple tiles each comprising DMA circuitry configured to receive pointers that indicate storage locations of DMA operations, fetch, by the DMA circuitry in the multiple tiles, the DMA operations using the pointers, and configure in parallel, by the DMA circuitry in the multiple tiles, DMA circuitry in multiple columns of the hardware accelerator array to perform the DMA operations.

One embodiment described herein is a system that a hardware accelerator array including multiple tiles each comprising DMA circuitry that is configured to fetch, by the DMA circuitry in the multiple tiles, DMA operations, configure in parallel, by the DMA circuitry in the multiple tiles, DMA circuitry in multiple columns of the hardware accelerator to perform the DMA operations, and a compiler configured to generate a binary that includes the DMA operations for programming the hardware accelerator array to perform one or more functions.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a SoC with an AI accelerator, according to an example.

FIG. 2 illustrates an AI accelerator, according to an example.

FIG. 3 is a block diagram of an AI engine array, according to an example.

FIG. 4 is a flowchart for configuring DMA circuitry in a hardware accelerator array, according to an example.

FIG. 5 illustrates configuring DMA circuitry using an interface tile in a hardware accelerator array, according to an example.

FIG. 6 is a flowchart for configuring DMA circuitry in a hardware accelerator array, according to an example.

FIG. 7 is a block diagram of a data processing engine, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe using multiple DMA engines in a hardware accelerator array to program the DMA operations within the array. For example, a system on a chip (SoC) may include a controller that is external to the hardware accelerator array. While the controller can be used to program the DMA circuitry within the array, this can be slow since the controller may be compute limited. Instead, the embodiments herein describe techniques where the controller is provided (e.g., from the binary) pointers to the register reads and writes corresponding to the DMA operations. The controller can provide these pointers to multiple DMA engines in the hardware accelerator array (e.g., DMA circuitry in interface tiles) which fetch the DMA operations and program themselves, as well as other DMA circuitry in the array. As such, rather than the controller having to program the entire array, multiple DMA engines can be used, thereby greatly expanding the amount of available compute resource for configuring and programming the hardware accelerator array.

Instead of relying on the controller to provide the initial pointers, in another embodiment, the configuration process can be started by compute tiles within the hardware accelerator array. That is, instead of the pointers being loaded in the controller, the compute tiles (e.g., data processing engine (DPE) tiles) can provide the pointers to the DMA engines to start the process.

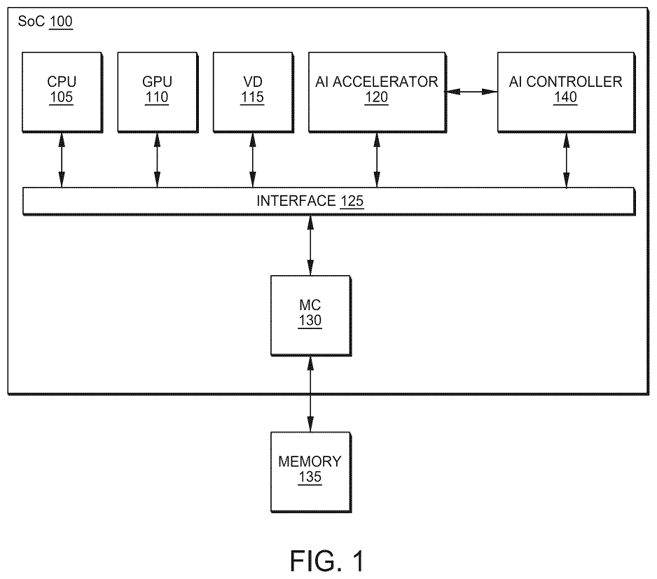

FIG. 1 illustrates a SoC 100 with an AI accelerator 120, according to an example. The SoC 100 can be a single IC or a single chip. In one embodiment, the SoC 100 includes a semiconductor substrate on which the illustrated components are formed using fabrication techniques.

The SoC 100 includes a CPU 105, GPU 110, VD 115, AI accelerator 120, interface 125, and MC 130. However, the SoC 100 is just one example of integrating an AI accelerator 120 into a shared platform with the CPU 105. In other examples, a SoC may include fewer components than what is shown in FIG. 1. For example, the SoC may not include the VD 115 or an internal GPU 110. However, in other examples, the SoC may include additional components than the ones shown in FIG. 1. Thus, FIG. 1 is just one example of components that can be integrated into a SoC with the AI accelerator 120.

The CPU 105 can represent any number of processors where each processor can include any number of cores. For example, the CPU 105 can include processors arranged in array, or the CPU 105 can include an array of cores. In one embodiment, the CPU 105 is an x86 processor that uses a corresponding complex instruction set. However, in other embodiments, the CPU 105 may be other types of CPUs such as an Advanced Reduced Set Instruction Computer (RSIC) Machine (ARM) processor.

The GPU 110 is an internal GPU 110 that performs accelerated computer graphics and image processing. The GPU 110 can include any number of different processing elements. In one embodiment, the GPU 110 can perform non-graphical tasks such as training an AI model or cryptocurrency mining.

The VD 115 can be used for decoding and encoding videos.

The AI accelerator 120 can include any hardware circuitry that is designed to perform AI tasks, such as inference. In one embodiment, the AI accelerator 120 includes an array of DPEs that performs calculations that are part of an AI task. These calculations can include math operations or logic operations (e.g., bit shifts and the like). The details of the AI accelerator 120 will be discussed in more detail below.

The SoC 100 also includes one or more MCs 130 for controlling memory 135 (e.g., random access memory (RAM)). While the memory 135 is shown as being external to the SoC 100 (e.g., on a separate chip or chiplet), the MCs 130 could also control memory that is internal to the SoC 100.

The CPU 105, GPU 110, VD 115, AI accelerator 120, and MC 130 are communicatively coupled using an interface 125. Put differently, the interface permits the different types of circuitry in the SoC 100 to communicate with each other. For example, the CPU 105 can use the interface 125 to instruct the AI accelerator 120 to perform an AI task. The AI accelerator 120 can use the interface 125 to retrieve data (e.g., input for the AI task) from the memory 135 via the MC 130, process the data to generate a result, store the result in the memory 135 using the interface 125, and then inform the CPU 105 that the AI task is complete using the interface 125.

In one embodiment, the interface 125 is a NoC, but other types of interfaces such as internal buses are also possible.

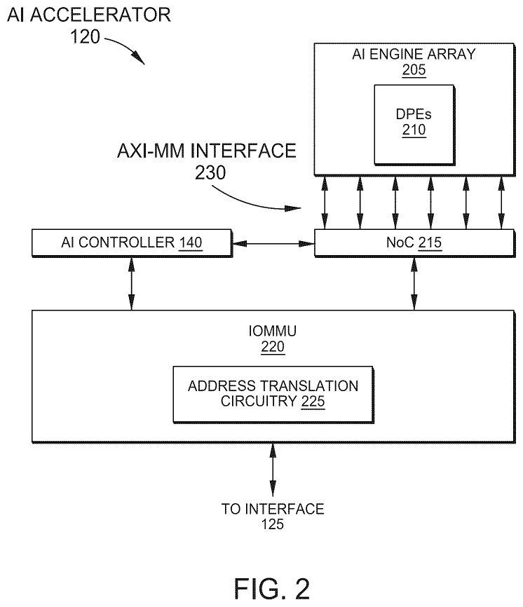

FIG. 2 illustrates the AI accelerator 120, according to an example. The Al accelerator 120 can also be described as an inference processing unit (IPU) but is not limited to performing AI inference tasks.

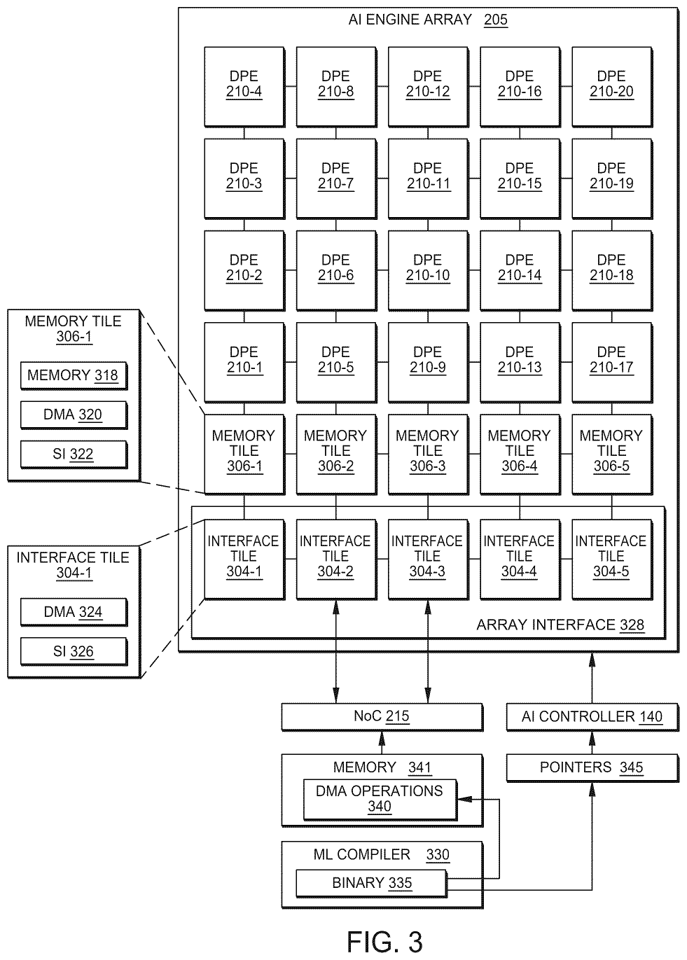

The accelerator 120 includes an AI engine array 205 that includes a plurality of DPEs 210 (which can also be referred to as AI engines). The DPEs 210 may be arranged in a grid, cluster, or checkerboard pattern in the SoC 100 in FIG. 1—e.g., a 2D array with rows and columns. Further, the array 205 can be any size and have any number of rows and columns formed by the DPEs 210. One example layout of the array 205 is shown in FIG. 3.

In one embodiment, the DPEs 210 are identical. That is, each of the DPEs 210 (also referred to as tiles or blocks) may have the same hardware components or circuitry. In one embodiment, the array 205 includes DPEs 210 that are all the same type (e.g., a homogeneous array). However, in another embodiment, the array 205 may include different types of engines.

Regardless if the array 205 is homogenous or heterogeneous, the DPEs 210 can include direct connections between DPEs 210 which permit the DPEs 210 to transfer data directly to neighboring DPEs. Moreover, the array 205 can include a switched network that uses switches that facilitate communication between neighboring and non-neighboring DPEs 210 in the array 205.

In one embodiment, the DPEs 210 are formed from software-configurable hardened logic—i.e., are hardened. One advantage of doing so is that the DPEs 210 may take up less space in the SoC relative to using programmable logic to form the hardware elements in the DPEs 210. That is, using hardened logic circuitry to form the hardware elements in the DPE 210 such as program memories, an instruction fetch/decode unit, fixed-point vector units, floating-point vector units, arithmetic logic units (ALUs), multiply accumulators (MAC), and the like can significantly reduce the footprint of the array 205 in the SoC. Although the DPEs 210 may be hardened, this does not mean the DPEs 210 are not programmable. That is, the DPEs 210 can be configured when the SoC is powered on or rebooted to perform different AI functions or tasks.

While an AI accelerator 120 is shown, the embodiments herein can be extended to other types of integrated accelerators. For example, the accelerator could include an array of DPEs for performing other tasks besides AI tasks. For instance, the DPEs 210 could be digital signal processing engines, cryptographic engines, Forward Error Correction (FEC) engines, or other specialized hardware for performing one or more specialized tasks. In that case, the accelerator could be a cryptography accelerator, compression accelerator, and so forth.

In this example, the DPEs 210 in the array 205 use the Advanced extensible Interface (AXI) memory-mapped (MM) interface 230 to communicate with a NoC 215. AXI is an on-chip communication bus protocol that is part of the Advanced Microcontroller Bus Architecture (AMBA) specification. An AXI MM interface 230 is used (rather than a AXI streaming interface) to transfer data between the DPEs 210 and the NoC 215 to access external memory, which requires using physical memory addresses. The DPEs can communicate with each other using a streaming protocol or interface (e.g., AXI streaming which does not use memory addresses) but a memory mapped protocol or interface (e.g., AXI MM) is used when transmitting data external to the array 205. In one embodiment, the array 205 can include interface tile (such as the interface tile 304 discussed in FIG. 3) that include primary and secondary DMA interfaces for transmitting data into and out of the array. When receiving data from the NoC 215, the interface tiles in the array 205 can transform the data into AXI streaming data.

In one embodiment, a memory mapped interface is also used to communicate between the NoC 215 and the IOMMU 220, and between the IOMMU 220 and the interface 125. However, these interfaces may be different types of memory mapped interfaces. For example, the interface between the NoC 215 and the IOMMU 220 may be AXI-MM, while the interface between the IOMMU 220 and the interface 125 is a different type of memory mapped interface. While AXI is discussed as one example herein, any suitable memory mapped and streaming interfaces may be used.

The NoC 215 may be a smaller interface than the interface 125 in FIG. 1. For example, the NoC 215 may be a miniature NoC when compared to using a NoC to implement the interface 125 in FIG. 1. The NoC 215 permits the DPEs 210 in the different columns of the AI engine array 205 to communicate with an IOMMU 220. The NoC 215 can include a plurality of interconnected switches. For example, the switches may be connected to their neighboring switches using north, east, south, and west connections.

In one embodiment, the data in the AI accelerator 120 is tracked using virtual memory addresses. However, other circuitry in the SoC 100 (e.g., caches in the CPUs 105, memory in the GPUs 110, the MC 130, etc.) may use physical memory addresses to store the data. The IOMMU 220 includes address translation circuitry 225 to perform memory address translation on data that flows into, and out of, the AI accelerator 120. For example, when receiving data from other circuitry in the SoC (e.g., from the MCs 130) via the interface 125, the address translation circuitry 225 may perform a physical-to-virtual address translation. When transmitting data from the AI accelerator 120 to be stored in the SoC or external memory 135 using the interface 125, the address translation circuitry 225 performs a virtual-to-physical address translation. For example, when using AXI-MM, the address translation circuitry 225 performs a translation between AXI-MM virtual addresses to physical addresses used to store the data in external memory or caches. While FIG. 2 illustrates using an IOMMU, the address translation function may be implemented using any suitable type of address translation circuitry.

FIG. 3 is a block diagram of an AI engine array 205, according to an example. In this example, AI engine array 205 includes a plurality of circuit blocks, or tiles, illustrated here as the DPEs 210 (also referred to as DPE tiles or compute tiles), interface tiles 304, and memory tiles 306. Memory tiles 306 may be referred to as shared memory and/or shared memory tiles. Interface tiles 304 may be referred to as shim tiles, and may be collectively referred to as an array interface 328. Like in FIG. 2, the AI engine array 205 is coupled to the NoC 215. FIG. 3 further illustrates that the interface tiles 304 communicatively couple the other tiles in the AI engine array 205 (i.e., the DPEs 210 and memory tiles 306) to the NoC 215.

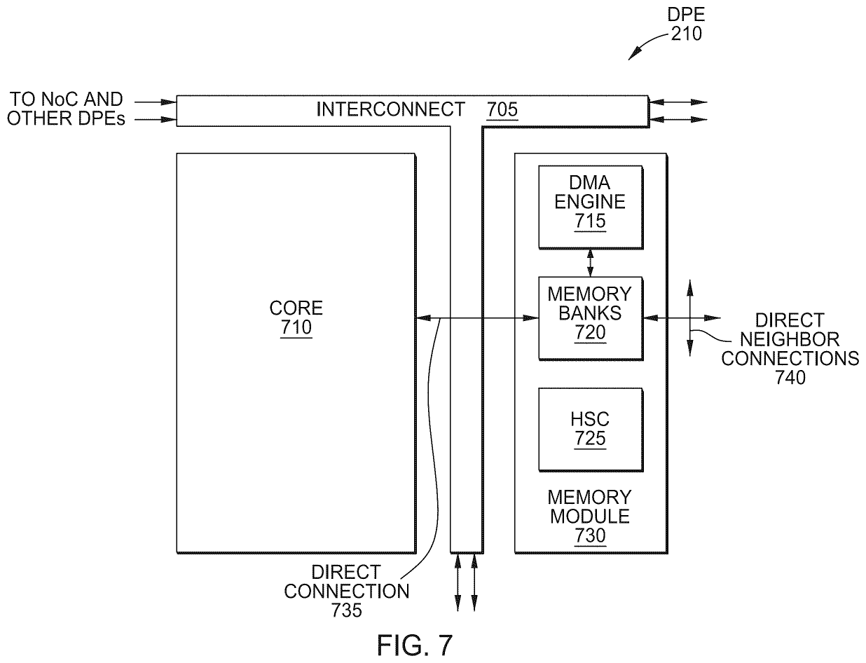

DPEs 210 can include one or more processing cores, program memory (PM), data memory (DM), DMA circuitry, and stream interconnect (SI) circuitry, which are also described in FIG. 7. For example, the core(s) in the DPEs 210 can execute program code stored in the PM. The core(s) may include, without limitation, a scalar processor and/or a vector processor. DM may be referred to herein as local memory or local data memory, in contrast to the memory tiles which have memory that is external to the DPE tiles, but still within the AI engine array 205.

The core(s) may directly access data memory of other DPE tiles via DMA circuitry. The core(s) may also access DM of adjacent (or neighboring) DPEs 210 via DMA circuitry and/or DMA circuitry of the adjacent compute tiles. In one embodiment, DM in one DPE 210 and DM of adjacent DPE tiles may be presented to the core(s) as a unified region of memory. In one embodiment, the core(s) in one DPE 210 may access data memory of non-adjacent DPEs 210. Permitting cores to access data memory of other DPE tiles may be useful to share data amongst the DPEs 210.

The AI engine array 205 may include direct core-to-core cascade connections (not shown) amongst DPEs 210. Direct core-to-core cascade connections may include unidirectional and/or bidirectional direct connections. Core-to-core cascade connections may be useful to share data amongst cores of the DPEs 210 with relatively low latency. For example, a direct core-to-core cascade connection may be useful to provide results from an accumulation register of a processing core of an originating DPE directly to a processing core(s) of a destination DPE.

In an embodiment, DPEs 210 do not include cache memory. Omitting cache memory may be useful to provide predictable/deterministic performance. Omitting cache memory may also be useful to reduce processing overhead associated with maintaining coherency among cache memories across the DPEs 210.

In an embodiment, processing cores of the DPE 210 do not utilize input interrupts. Omitting interrupts may be useful to permit the processing cores to operate uninterrupted. Omitting interrupts may also be useful to provide predictable and/or deterministic performance.

One or more DPEs 210 may include special purpose or specialized circuitry, or may be configured as special purpose or specialized compute tiles such as, without limitation, digital signal processing engines, cryptographic engines, forward error correction (FEC) engines, and/or artificial intelligence (AI) engines.

In an embodiment, the DPEs 210, or a subset thereof, are substantially identical to one another (i.e., homogenous compute tiles). Alternatively, one or more DPEs 210 may differ from one other more other DPEs 210 (i.e., heterogeneous compute tiles).

Memory tile 306-1 includes memory 318 (e.g., random access memory or RAM), DMA circuitry 320, and stream interconnect (SI) circuitry 322.

Memory tile 306-1 may lack or omit computational components such as an instruction processor. In an embodiment, memory tiles 306, or a subset thereof, are substantially identical to one another (i.e., homogenous memory tiles). Alternatively, one or more memory tiles 306 may differ from one other more other memory tiles 306 (i.e., heterogeneous memory tiles). A memory tile 306 may be accessible to multiple DPEs 210. Memory tiles 306 may thus be referred to as shared memory.

Data may be moved between/amongst memory tiles 306 via DMA circuitry 320 and/or stream interconnect circuitry 322 of the respective memory tiles 306. Data may also be moved between/amongst data memory of a DPE 210 and memory 318 of a memory tile 306 via DMA circuitry and/or stream interconnect circuitry of the respective tiles. For example, DMA circuitry in a DPE 210 may read data from its data memory and forward the data to memory tile 306-1 in a write command, via stream interconnect circuitry in the DPE 210 and stream interconnect circuitry 322 in the memory tile 306. DMA circuitry 324 of memory tile 306-1 may then write the data to memory 318. As another example, DMA circuitry 320 of memory tile 306-1 may read data from memory 318 and forward the data to a DPE 210 in a write command, via stream interconnect circuitry 322 and stream interconnect circuitry in the DPE 210, and DMA circuitry in the DPE 210 can write the data to its data memory.

Array interface 328 interfaces between the AI engine array 205 (e.g., DPEs 210 and memory tiles 306) and the NoC 215. Interface tile 304-1 includes DMA circuitry 324 and stream interconnect circuitry 326. Interface tiles 304 may be interconnected so that data may be propagated amongst interface tiles 304 bi-directionally. An interface tile 304 may operate as an interface for the columns of DPEs 210 (e.g., as an interface to the NoC 215). Interface tiles 304 may be connected such that data may be propagated from one interface tile 304 to another interface tile 304 bi-directionally.

In an embodiment, interface tiles 304, or a subset thereof, are substantially identical to one another (i.e., homogenous interface tiles). Alternatively, one or more interface tiles 304 may differ from other interface tiles 304 (i.e., heterogeneous interface tiles).

In an embodiment, one or more interface tiles 304 are configured as a NoC interface tile (e.g., as master and/or slave device) that interface between the DPEs 210 and the NoC 215 (e.g., to access other components in the SoC). While FIG. 3 illustrates coupling a subset of the interface tiles 304 to the NoC 215, in one embodiment, each of the interface tiles 304-1-5 is connected to the NoC 215. Doing so may permit different applications to control and use different columns of the memory tiles 306 and DPEs 210.

DMA circuitry and stream interconnect circuitry of the AI engine array 205 may be configurable/programmable to provide desired functionality and/or connections to move data between/amongst DPEs 210, memory tiles 306, and the NoC 215. The DMA circuitry and stream interconnect circuitry of the AI engine array 205 may include, without limitation, switches and/or multiplexers that are configurable to establish signal paths within, amongst, and/or between tiles of the AI engine array 205. The AI engine array 205 may further include configurable AXI interface circuitry. The DMA circuitry, the stream interconnect circuitry, and/or AXI interface circuitry may be configured or programmed by storing configuration parameters in configuration registers, configuration memory (e.g., configuration random access memory or CRAM), and/or eFuses, and coupling read outputs of the configuration registers, CRAM, and/or eFuses to functional circuitry (e.g., to a control input of a multiplexer or switch), to maintain the functional circuitry in a desired configuration or state. In an embodiment, the core(s) of DPEs 210 configure the DMA circuitry and stream interconnect circuitry of the respective DPEs 210 based on core code stored in PM of the respective DPEs 210.

The controller 140 can configure or program DMA circuitry and stream interconnect circuitry of memory tiles 306 and interface tiles 304 based on controller code. In FIG. 3, the controller code is based on a binary 335 generated by a ML compiler 330. For example, the ML compiler 330 may receive as an input a ML model (or AI model) which it then compiles to create the binary 335 for performing functions of the ML model. For example, the binary 335 can include high-level commands such as ML operations like executing a convolution, RELU, softmax, and the like.

In this example, the binary 335 includes DMA operations 340 and pointers 345. The DMA operations 340 can include DMA instructions (e.g., register reads or buffer descriptors) for performing the ML operations (e.g., convolution, RELU, softmax, etc.) using the DPEs 210. For example, the DMA operations 340 may configure or program the interface tiles 304 and the memory tiles 306 to retrieve the data for the DPEs 210 to process in order to perform the ML operations.

The pointers 345 can be memory addresses (or memory ranges) that point to the storage locations of the DMA operations 340 in memory 341. That is, the pointers 345 can be used to identify where the DMA operations 340 for the binary 335 are stored in memory 341 which can be memory on the same SoC as the array 205, or external memory.

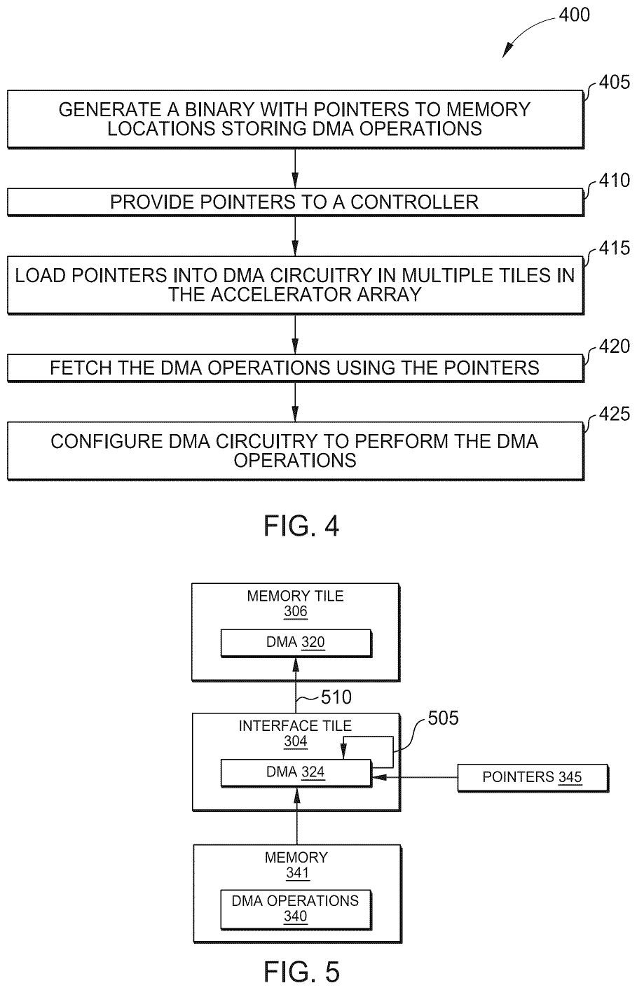

As shown, the pointers 345 are provided to the AI controller 140 which can use the pointers 345 to configure the DMA 324 in the interface tiles 304 to fetch the DMA operations 340 from memory. The DMA 324 can then configure themselves, as well as the DMA 320 in the memory tile 306 to perform the DMA operations 340. Thus, instead of the AI controller 140 having to configure/program the DMA circuitry 320, 324, this task can be delegated to the DMA circuitry 324. In one embodiment, the DMA circuitry 324 of the interface tile 304 in each column programs itself as well as the DMA circuitry 320 in the same column. As such, the DMA circuitry in each column can be programmed in parallel using the DMA circuitry 324 in the respective interface tiles 304, rather than the AI controller 140 having to program every column. This is discussed in more detail in FIG. 4 below.

In one embodiment, the ML compiler 330 is executed on a computing system external to the SoC that contains the AI engine array 205. For example, the ML compiler 330 may execute on a host, or a separate computing device. However, in other embodiments, the ML compiler 330 may execute on the same SoC as the array 205. For example, the ML compiler 330 may be executed on the CPU 105 in FIG. 1.

The AI engine array 205 may include a hierarchical memory structure. For example, data memory of the DPEs 210 may represent a first level (L1) of memory, memory 318 of memory tiles 306 may represent a second level (L2) of memory, and external memory outside the AI engine array 205 may represent a third level (L3) of memory. Memory capacity may progressively decrease with each level (e.g., memory 318 of memory tile 306 may have more storage capacity than data memory in the DPEs 210, and external memory may have more storage capacity than data memory 318 of the memory tiles 306). The hierarchical memory structure is not, however, limited to the foregoing examples.

As an example, an input tensor may be relatively large (e.g., 1 megabyte or MB). Local data memory in the DPEs 210 may be significantly smaller (e.g., 64 kilobytes or KB). The controller may segment an input tensor and store the segments in respective blocks of shared memory tiles 306.

FIG. 4 is a flowchart of a method 400 for configuring DMA circuitry in a hardware accelerator array, according to an example. At block 405, a compiler generates a binary (e.g., an executable) with pointers to memory locations storing DMA operations. For example, the compiler may be a ML compiler that generates DMA operations for performing ML operations. However, the embodiments herein are not limited to such and can include compilers that generate binaries for other types of applications such as digital signal processing, cryptography, data compression, and the like, which are then performed on the hardware accelerator array.

The DMA operations can include the registers writes (e.g., buffer descriptors) that have to be performed in order to perform the functions of the associated application (e.g., a ML model). The DMA operations can be an image that is stored in memory.

In one embodiment, the compiler stores the DMA operations in a memory that is accessible to the hardware accelerator array. That is, the DMA operations can be retrieved by the accelerator, such as DMA circuitry (e.g., DMA engines) in the interface tiles of the hardware accelerator array. The DMA operations may be stored in memory that is on the same chip/IC (e.g., same SoC) as the hardware accelerator array, or may be stored in external memory (e.g., high bandwidth memory (HBM) that is disposed on a common substrate as the SoC containing the hardware accelerator array).

The compiler can also generate pointers to the memory locations storing the DMA operations. These pointers can be used to retrieve the DMA operations from memory.

At block 410, the compiler provides the pointers to a controller of the hardware accelerator array (e.g., the AI controller 140 in FIG. 1). For example, the compiler may store the pointers in memory that is accessible to the controller.

At block 415, the controller loads the pointers into DMA circuitry in multiple tiles in the accelerator array. The pointers inform the DMA circuitry of the location of the DMA operations (e.g., the register writes) that should be performed in order to perform the desired operations.

In one embodiment, the controller loads the pointers into DMA engines in interface tiles of the array. As shown in FIG. 3, the interface tiles 304 serve as an interface between the other tiles in the array 205 (e.g., the DPEs 210 and the memory tiles 306) and the NoC 215. The controller 140 can use the pointers 345 to program the DMA 324 in the interface tiles 304 to retrieve the DMA operations 340. Thus, while the AI controller 140 still participates in the procedure for configuring the array 205 (e.g., the controller starts or kicks off the process), its workload is greatly reduced relative to relying on the controller 140 to program the DMA circuitry in each of the tiles in the array 205.

While the AI controller 140 may configure the DMA circuitry 324 in each of the interface tiles 304 to retrieve the DMA operations 340, in other embodiments, only a subset of the interface tiles 304 may be used. In any case, multiple interface tiles 304 in the array 205 can be used.

Further, the embodiments herein are not limited to using DMA circuitry 324 in the interface tiles 304 to retrieve the DMA operations. For instance, the DMA circuitry 320 in the memory tiles 306 may be used to retrieve the DMA operations, or a combination of the DMA circuitry 320 in the memory tiles 306 as well as the DMA circuitry 324 in the interface tiles 304.

At block 420, the DMA circuitry fetches the DMA operations using the pointers. Advantageously, the DMA circuitry in different tiles can work in parallel to fetch the DMA operations.

At block 425, the DMA circuitry configures itself and potentially other DMA circuitry to perform the DMA operations. For example, the DMA circuitry in each column may fetch DMA operations for that particular column, and configure the DMA circuitry in that column to perform those operations. Thus, each column of the accelerator array can be programmed in parallel by respective DMA circuitry, which could be in the interface tiles, or some other tile in each of the columns.

FIG. 5 illustrates configuring DMA circuitry using an interface tile in a hardware accelerator array, according to an example. FIG. 5 illustrates an interface tile 304 that configures itself and other DMA circuitry in the memory tile 306 to perform DMA operations. FIG. 5 is one example of performing block 425 in FIG. 4.

As shown, the DMA circuitry 324 in the interface tile 304 (e.g., a DMA engine) receives the DMA operations 340. The DMA circuitry 324 can use pointers 345, which may be provided by a controller or some other entity, to identify the storage location of the DMA operations 340 in memory. In one embodiment, the DMA circuitry 324 can use DMA to read the DMA operations 340 from memory.

As shown by arrow 505, the DMA circuitry 324 programs (or configures) itself to perform a portion of the DMA operations. For example, the DMA operations 340 can include register writes/reads that are performed by the DMA 324. These register writes and reads can move data into (and out of) the accelerator array in order for the DPEs in the array (not shown here) to perform the desired functions (e.g., a function of a ML model).

In addition, arrow 510 illustrates the DMA circuitry 324 programming or configuring the DMA circuitry 320 in the memory tile 305. Thus, in this example, the DMA operations 340 includes register writes/reads that are performed by the DMA circuitry 320 in the memory tile 306. These register writes and reads also can move data into (and out of) the accelerator array in order for the DPEs in the array to perform the desired functions (e.g., a function of a ML model).

While FIG. 5 illustrates the DMA 324 in the interface tile 304 configuring the DMA 320 in the memory tile 306, the DMA 324 can configure any number of DMA engines in any number of other tiles. In one embodiment, the DMA 324 configures DMA only in tiles that are in the same column as the interface tile 304. However, in other examples the DMA 324 may configure or program DMA in tiles that are in different columns than the interface tile 304 (e.g., the DMA 324 may be tasked with programming DMA circuitry in multiple columns to perform the DMA operations 340).

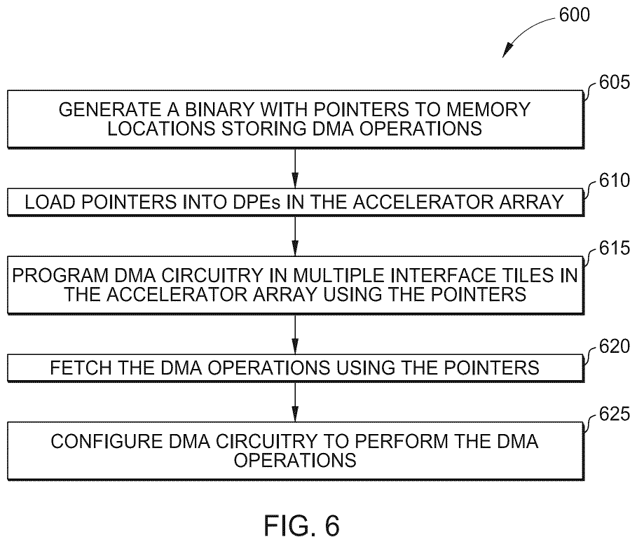

FIG. 6 is a flowchart of a method 600 for configuring DMA circuitry in a hardware accelerator array, according to an example. Unlike in FIG. 3 and FIG. 4 where the controller (e.g., the AI controller 140) starts off the configuration or programming of the DMA circuitry, in method 600 the DPEs can kick off the configuration or programming process.

At block 605, a compiler generates a binary (e.g., an executable) with pointers to memory locations storing DMA operations. For example, the compiler may be a ML compiler that generates DMA operations for performing ML operations. However, the embodiments herein are not limited to such and can include compilers that generate binaries for other types of applications such as digital signal processing, cryptography, data compression, and the like.

At block 610, the compiler loads the pointers into DPEs in the accelerator array (e.g., the DPEs 210 in FIG. 3). For example, the pointers may be loaded into one DPE in each of the columns in the accelerator array, or the pointers may be loaded into multiple DPEs in the same column. In yet another example, the pointers may be loaded into only a handful DPEs that are in a subset of the columns.

At block 615, the DPEs program DMA circuitry in multiple interface tiles in the accelerator array using the pointers. That is, the DPEs perform a similar task as the controller did in the method 400. The DPEs can load the pointers into DMA circuitry in multiple tiles in the accelerator array. The pointers inform the DMA circuitry of the location of the DMA operations (e.g., the register writes) that should be performed in order to perform the desired operations.

In one embodiment, the DPEs load the pointers into DMA engines in interface tiles of the array. The DPEs can use the pointers to program the DMA in the interface tiles 304 to retrieve the DMA operations.

While the DPEs may configure the DMA circuitry 324 in each of the interface tiles 304 in FIG. 3 to retrieve the DMA operations 340, in other embodiments, only a subset of the interface tiles 304 may be used. In any case, multiple interface tiles 304 can be used.

Further, the embodiments herein are not limited to using DMA circuitry 324 in the interface tiles 304 to retrieve the DMA operations. For instance, the DMA circuitry 320 in the memory tiles 306 may be used to retrieve the DMA operations, or a combination of the DMA circuitry 320 in the memory tiles 306 as well as the DMA circuitry 324 in the interface tiles 304.

At block 620, the DMA circuitry fetches the DMA operations using the pointers. Advantageously, the DMA circuitry in different tiles can work in parallel to fetch the DMA operations.

At block 625, the DMA circuitry configures itself and potentially other DMA circuitry to perform the DMA operations. For example, the DMA circuitry in each column may fetch DMA operations for that particular column, and configure the DMA circuitry in that column to perform those operations. Thus, each column of the accelerator array can be programmed in parallel by respective DMA circuitry, which could be in the interface tiles, or some other tile in each of the columns. One example of performing block 625 was discussed in FIG. 5 above.

FIG. 7 is a block diagram of a data processing engine, according to an example. FIG. 7 is a block diagram of a DPE 210 in the AI engine array 205 illustrated in FIG. 2, according to an example. The DPE 210 includes an interconnect 705, a core 710, and a memory module 730. The interconnect 705 permits data to be transferred from the core 710 and the memory module 730 to different cores in the array. That is, the interconnect 705 in each of the DPEs 210 may be connected to each other so that data can be transferred north and south (e.g., up and down) as well as east and west (e.g., right and left) between the DPEs 210 in the array.

For example, the DPEs 210 in an upper row of the array rely on the interconnects 705 in the DPEs 210 in a lower row to communicate with the NoC 215 shown in FIG. 2. For example, to transmit data to the NoC, a core 710 in a DPE 210 in the upper row transmits data to its interconnect 705 which is in turn communicatively coupled to the interconnect 705 in the DPE 210 in the lower row. The interconnect 705 in the lower row is connected to the NoC. The process may be reversed where data intended for a DPE 210 in the upper row is first transmitted from the NoC to the interconnect 705 in the lower row and then to the interconnect 705 in the upper row that is the target DPE 210. In this manner, DPEs 210 in the upper rows may rely on the interconnects 705 in the DPEs 210 in the lower rows to transmit data to and receive data from the NoC.

In one embodiment, the interconnect 705 includes a configurable switching network that permits the user to determine how data is routed through the interconnect 705. In one embodiment, unlike in a packet routing network, the interconnect 705 may form streaming point-to-point connections. That is, the streaming connections and streaming interconnects in the interconnect 705 may form routes from the core 710 and the memory module 730 to the neighboring DPEs 210 or the NoC. Once configured, the core 710 and the memory module 730 can transmit and receive streaming data along those routes. In one embodiment, the interconnect 705 is configured using the AXI Streaming protocol. However, when communicating with the NoC, the DPEs 210 may use the AXI MM protocol.

In addition to forming a streaming network, the interconnect 705 may include a separate network for programming or configuring the hardware elements in the DPE 210. Although not shown, the interconnect 705 may include a memory mapped interconnect (e.g., AXI MM) which includes different connections and switch elements used to set values of configuration registers in the DPE 210 that alter or set functions of the streaming network, the core 710, and the memory module 730.

In one embodiment, streaming interconnects (or network) in the interconnect 705 support two different modes of operation referred to herein as circuit switching and packet switching. In one embodiment, both of these modes are part of, or compatible with, the same streaming protocol-e.g., an AXI Streaming protocol. Circuit switching relies on reserved point-to-point communication paths between a source DPE 210 to one or more destination DPEs 210. In one embodiment, the point-to-point communication path used when performing circuit switching in the interconnect 705 is not shared with other streams (regardless whether those streams are circuit switched or packet switched). However, when transmitting streaming data between two or more DPEs 210 using packet-switching, the same physical wires can be shared with other logical streams.

The core 710 may include hardware elements for processing digital signals. For example, the core 710 may be used to process signals related to wireless communication, radar, vector operations, machine learning applications, and the like. As such, the core 710 may include program memories, an instruction fetch/decode unit, fixed-point vector units, floating-point vector units, arithmetic logic units (ALUs), multiply accumulators (MAC), and the like. However, as mentioned above, this disclosure is not limited to DPEs 210. The hardware elements in the core 710 may change depending on the engine type. That is, the cores in an AI engine, digital signal processing engine, cryptographic engine, or FEC may be different.

The memory module 730 includes a DMA engine 715, memory banks 720, and hardware synchronization circuitry (HSC) 725 or other type of hardware synchronization block. In one embodiment, the DMA engine 715 enables data to be received by, and transmitted to, the interconnect 705. That is, the DMA engine 715 may be used to perform DMA reads and write to the memory banks 720 using data received via the interconnect 705 from the NoC or other DPEs 210 in the array.

The memory banks 720 can include any number of physical memory elements (e.g., SRAM). For example, the memory module 730 may be include 4, 8, 16, 32, etc. different memory banks 720. In this embodiment, the core 710 has a direct connection 735 to the memory banks 720. Stated differently, the core 710 can write data to, or read data from, the memory banks 720 without using the interconnect 705. That is, the direct connection 735 may be separate from the interconnect 705. In one embodiment, one or more wires in the direct connection 735 communicatively couple the core 710 to a memory interface in the memory module 730 which is in turn coupled to the memory banks 720.

In one embodiment, the memory module 730 also has direct connections 740 to cores in neighboring DPEs 210. Put differently, a neighboring DPE in the array can read data from, or write data into, the memory banks 720 using the direct neighbor connections 740 without relying on their interconnects or the interconnect 705 shown in FIG. 7. The HSC 725 can be used to govern or protect access to the memory banks 720. In one embodiment, before the core 710 or a core in a neighboring DPE can read data from, or write data into, the memory banks 720, the core (or the DMA engine 715) requests a lock acquire to the HSC 725 when it wants to read or write to the memory banks 720 (i.e., when the core/DMA engine want to “own” a buffer, which is an assigned portion of the memory banks 720. If the core or DMA engine does not acquire the lock, the HSC 725 will stall (e.g., stop) the core or DMA engine from accessing the memory banks 720. When the core or DMA engine is done with the buffer, they release the lock to the HSC 725. In one embodiment, the HSC 725 synchronizes the DMA engine 715 and core 710 in the same DPE 210 (i.e., memory banks 720 in one DPE 210 are shared between the DMA engine 715 and the core 710). Once the write is complete, the core (or the DMA engine 715) can release the lock which permits cores in neighboring DPEs to read the data.

Because the core 710 and the cores in neighboring DPEs 210 can directly access the memory module 730, the memory banks 720 can be considered as shared memory between the DPEs 210. That is, the neighboring DPEs can directly access the memory banks 720 in a similar way as the core 710 that is in the same DPE 210 as the memory banks 720. Thus, if the core 710 wants to transmit data to a core in a neighboring DPE, the core 710 can write the data into the memory bank 720. The neighboring DPE can then retrieve the data from the memory bank 720 and begin processing the data. In this manner, the cores in neighboring DPEs 210 can transfer data using the HSC 725 while avoiding the extra latency introduced when using the interconnects 705. In contrast, if the core 710 wants to transfer data to a non-neighboring DPE in the array (i.e., a DPE without a direct connection 740 to the memory module 730), the core 710 uses the interconnects 705 to route the data to the memory module of the target DPE which may take longer to complete because of the added latency of using the interconnect 705 and because the data is copied into the memory module of the target DPE rather than being read from a shared memory module.

In addition to sharing the memory modules 730, the core 710 can have a direct connection to cores 710 in neighboring DPEs 210 using a core-to-core communication link (not shown). That is, instead of using either a shared memory module 730 or the interconnect 705, the core 710 can transmit data to another core in the array directly without storing the data in a memory module 730 or using the interconnect 705 (which can have buffers or other queues). For example, communicating using the core-to-core communication links may use less latency (or have high bandwidth) than transmitting data using the interconnect 705 or shared memory (which requires a core to write the data and then another core to read the data) which can offer more cost effective communication. In one embodiment, the core-to-core communication links can transmit data between two cores 710 in one clock cycle. In one embodiment, the data is transmitted between the cores on the link without being stored in any memory elements external to the cores 710. In one embodiment, the core 710 can transmit a data word or vector to a neighboring core using the links every clock cycle, but this is not a requirement.

In one embodiment, the communication links are streaming data links which permit the core 710 to stream data to a neighboring core. Further, the core 710 can include any number of communication links which can extend to different cores in the array. In this example, the DPE 210 has respective core-to-core communication links to cores located in DPEs in the array that are to the right and left (east and west) and up and down (north or south) of the core 710. However, in other embodiments, the core 710 in the DPE 210 illustrated in FIG. 7 may also have core-to-core communication links to cores disposed at a diagonal from the core 710. Further, if the core 710 is disposed at a bottom periphery or edge of the array, the core may have core-to-core communication links to only the cores to the left, right, and bottom of the core 710.

However, using shared memory in the memory module 730 or the core-to-core communication links may be available if the destination of the data generated by the core 710 is a neighboring core or DPE. For example, if the data is destined for a non-neighboring DPE (i.e., any DPE that DPE 210 does not have a direct neighboring connection 740 or a core-to-core communication link), the core 710 uses the interconnects 705 in the DPEs to route the data to the appropriate destination. As mentioned above, the interconnects 705 in the DPEs 210 may be configured when the SoC is being booted up to establish point-to-point streaming connections to non-neighboring DPEs to which the core 710 will transmit data during operation.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

1. A method, comprising:
loading pointers into direct memory access (DMA) circuitry in multiple tiles arranged in multiple columns in a hardware accelerator array, wherein the pointers indicate storage locations of DMA operations;
fetching, by the DMA circuitry in the multiple tiles, the DMA operations using the pointers; and
configuring in parallel, by the DMA circuitry in the multiple tiles, DMA circuitry in the multiple columns of the hardware accelerator array to perform the DMA operations.

2. The method of claim 1, wherein the multiple tiles include at least one tile in each of the columns in the hardware accelerator array.

3. The method of claim 1, wherein the multiple tiles are interface tiles that are in a row of the hardware accelerator array that connect other tiles in the hardware accelerator array with other hardware components on a same integrated circuit as the hardware accelerator array.

4. The method of claim 3, wherein configuring in parallel the DMA circuitry in the multiple columns comprises:
configuring both (i) the DMA circuitry in the interface tiles to perform the DMA operations and (ii) DMA circuitry in memory tiles in each of the columns to perform the DMA operations, wherein the memory tiles are disposed in a row that neighbors the row containing the interface tiles.

5. The method of claim 4, further comprising:
performing the DMA operations to enable data processing engine (DPE) tiles in the hardware accelerator array to perform one or more functions, wherein the memory tiles are disposed between the DPE tiles and the interface tiles.

6. The method of claim 5, wherein the one or more functions are part of a machine learning model, wherein the hardware accelerator array is an artificial intelligence engine array.

7. The method of claim 1, further comprising:
loading the pointers into a controller that controls the hardware accelerator array, wherein the controller loads the pointers into the DMA circuitry in the multiple tiles.

8. The method of claim 1, further comprising:
loading the pointers into DPE tiles in the hardware accelerator array, wherein the DPE tiles load the pointers into the DMA circuitry in the multiple tiles.

9. The method of claim 8, wherein each of the DPE tiles comprises a core, a memory module, and an interconnect, wherein the interconnects in the DPE tiles are interconnected so that the DPE tiles are able to transmit data between each other.

10. A hardware accelerator array, comprising:
multiple tiles arranged in multiple columns and each comprising DMA circuitry, the DMA circuitry configured to:
receive pointers that indicate storage locations of DMA operations;
fetch, by the DMA circuitry in the multiple tiles, the DMA operations using the pointers; and
configure in parallel, by the DMA circuitry in the multiple tiles, DMA circuitry in the multiple columns of the hardware accelerator array to perform the DMA operations.

11. The hardware accelerator array of claim 10, wherein the multiple tiles include at least one tile in each of the columns in the hardware accelerator array.

12. The hardware accelerator array of claim 10, wherein the multiple tiles are interface tiles that are in a row of the hardware accelerator array that connect other tiles in the hardware accelerator array with other hardware components on a same integrated circuit as the hardware accelerator array.

13. The hardware accelerator array of claim 12, wherein configuring in parallel the DMA circuitry in the multiple columns comprises:
configuring both (i) the DMA circuitry in the interface tiles to perform the DMA operations and (ii) DMA circuitry in memory tiles in each of the columns to perform the DMA operations, wherein the memory tiles are disposed in a row that neighbors the row containing the interface tiles.

14. The hardware accelerator array of claim 13, wherein the DMA operations enable DPE tiles in the hardware accelerator array to perform one or more functions, wherein the memory tiles are disposed between the DPE tiles and the interface tiles.

15. The hardware accelerator array of claim 14, wherein the one or more functions are part of a machine learning model, wherein the hardware accelerator array is an artificial intelligence engine array.

16. The hardware accelerator array of claim 10, wherein the pointers are loaded into the DMA circuitry in the multiple tiles using a controller that controls the hardware accelerator array.

17. The hardware accelerator array of claim 10, wherein the pointers are loaded into the DMA circuitry in the multiple tiles using DPE tiles in the hardware accelerator array.

18. The hardware accelerator array of claim 17, wherein each of the DPE tiles comprises a core, a memory module, and an interconnect, wherein the interconnects in the DPE tiles are interconnected so that the DPE tiles are able to transmit data between each other.

19. A system, comprising:
a hardware accelerator array comprising multiple tiles arranged in multiple columns and each comprising DMA circuitry, the DMA circuitry configured to:
fetch, by the DMA circuitry in the multiple tiles, DMA operations; and
configure in parallel, by the DMA circuitry in the multiple tiles, DMA circuitry in the multiple columns of the hardware accelerator array to perform the DMA operations; and
a compiler configured to generate a binary that includes the DMA operations for programming the hardware accelerator array to perform one or more functions.

20. The system of claim 19, wherein the one or more functions are part of a machine learning model that is compiled by the compiler, wherein the hardware accelerator array is an artificial intelligence engine array.
